(19) United States
(12) Patent Application Publication
(10) Pub. No.: US 2025/0384528 A1
(43) Pub. Date: Dec. 18, 2025

(54) MULTIMODAL GUIDANCE DISTILLATION FOR EFFICIENT DIFFUSION MODELS

(71) Applicant: QUALCOMM Incorporated, San Diego, CA (US)

(72) Inventors: Adil KARJAUV, Diemen (NL); Amir GHODRATI, Amsterdam (NL); Amirhossein HABIBIAN, Amsterdam (NL)

(21) Appl. No.: 18/770,606

(22) Filed: Jul. 11, 2024

Related U.S. Application Data
(60) Provisional application No. 63/660,127, filed on Jun. 14, 2024.

(51) Int. Cl. G06T 5/60

(52) U.S. Cl. CPC G06T 5/60; G06T 2207/20084

(57) ABSTRACT

Systems and techniques are described for image processing. For example, a computing device can obtain, via a neural network of a diffusion model, features associated with an input image, a plurality of conditioning inputs, and a plurality of guidance scale inputs. Each guidance scale input is associated with a respective conditioning input. The computing device can generate, using the neural network, output features based on the features associated with the input image, the plurality of conditioning inputs, and the plurality of guidance scale inputs. The computing device can generate, using the diffusion model, an output image based on the output features. The output image is a modified version of the input image based on the plurality of conditioning inputs.

### CROSS-REFERENCE TO RELATED APPLICATION

This application claims the benefit of, and priority to, U.S. Provisional Application No. 63/660,127, filed Jun. 14, 2024, which is hereby incorporated by reference, in its entirety and for all purposes.

### FIELD

The present disclosure generally relates to image processing. For example, aspects of the present disclosure relate to multimodal guidance distillation for efficient diffusion models.

### BACKGROUND

The increasing versatility of digital camera products has allowed digital cameras to be integrated into a wide array of devices and has expanded their use to different applications. For example, extended reality devices, phones, drones, cars, computers, televisions, and many other devices today are often equipped with camera devices. The camera devices allow users to capture images and/or video (e.g., including frames of images) from any system equipped with a camera device. The images and/or videos can be captured for recreational use, professional photography, surveillance, and automation, among other applications. Moreover, camera devices are increasingly equipped with specific functionalities for modifying images or creating artistic effects on the images. For example, many camera devices are equipped with image processing capabilities for generating different effects on captured images.

For image processing, generative models, such as diffusion models, can be employed to generate diverse high-resolution images. Generative models can be trained to generate image data based on provided conditions. One or more conditions (e.g., an image, video, text, a pose, and/an edge(s)) may be provided to a generative model. Image data generated by a generative model may be new image data (e.g., based on training of the generative model). The new image data may be conditioned on the provided image, but not replicated from the provided image.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for multimodal guidance distillation for efficient diffusion models. According to at least one example, an apparatus for image processing is provided. The apparatus includes one or more memories configured to store one or more features and one or more processors coupled to the one or more memories and configured to: obtain, via a neural network of a diffusion model, features associated with an input image, a plurality of conditioning inputs, and a plurality of guidance scale inputs, wherein each guidance scale input of the plurality of guidance scale inputs is associated with a respective conditioning input of the plurality of conditioning inputs; generate, using the neural network, output features based on the features associated with the input image, the plurality of conditioning inputs, and the plurality of guidance scale inputs; and generate, using the diffusion model, an output image based on the output features, wherein the output image is a modified version of the input image based on the plurality of conditioning inputs.

In some aspects, a method of image processing is provided. The method includes: obtaining, by a neural network of a diffusion model, features associated with an input image, a plurality of conditioning inputs, and a plurality of guidance scale inputs, wherein each guidance scale input of the plurality of guidance scale inputs is associated with a respective conditioning input of the plurality of conditioning inputs; generating, by the neural network, output features based on the features associated with the input image, the plurality of conditioning inputs, and the plurality of guidance scale inputs; and generating, by the diffusion model, an output image based on the output features, wherein the output image is a modified version of the input image based on the plurality of conditioning inputs.

In some aspects, a non-transitory computer-readable medium is provided having stored thereon instructions that, when executed by one or more processors, cause the one or more processors to: obtain, via a neural network of a diffusion model, features associated with an input image, a plurality of conditioning inputs, and a plurality of guidance scale inputs, wherein each guidance scale input of the plurality of guidance scale inputs is associated with a respective conditioning input of the plurality of conditioning inputs; generate, using the neural network, output features based on the features associated with the input image, the plurality of conditioning inputs, and the plurality of guidance scale inputs; and generate, using the diffusion model, an output image based on the output features, wherein the output image is a modified version of the input image based on the plurality of conditioning inputs.

In some aspects, an apparatus for image processing is provided. The apparatus includes: means for obtaining features associated with an input image, a plurality of conditioning inputs, and a plurality of guidance scale inputs, wherein each guidance scale input of the plurality of guidance scale inputs is associated with a respective conditioning input of the plurality of conditioning inputs; means for generating output features based on the features associated with the input image, the plurality of conditioning inputs, and the plurality of guidance scale inputs; and means for generating an output image based on the output features, wherein the output image is a modified version of the input image based on the plurality of conditioning inputs.

In some aspects, each of the apparatuses described above is, can be part of, or can include an audio device, a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example architecture of an image processing system, in accordance with some aspects of the present disclosure.

FIG. 2 is a block diagram illustrating an example implementation of a system, which may include a central processing unit (CPU), configured to perform one or more of the functions described herein, in accordance with some aspects of the present disclosure.

FIG. 3 includes two sets of images that show the forward diffusion process (which is fixed) and the reverse diffusion process (which is learned) of a diffusion model, in accordance with some aspects of the present disclosure.

FIG. 4 is a diagram illustrating how diffusion data is distributed from initial data to noise using a diffusion model in the forward diffusion direction, in accordance with some aspects of the present disclosure.

FIG. 5 is a diagram illustrating a U-Net architecture for a diffusion model, in accordance with some aspects of the present disclosure.

FIG. 6 is a diagram illustrating an example of a standard classifier-free guidance for multiple conditionings inference diffusion model, in accordance with some aspects of the present disclosure.

FIG. 7 is a diagram illustrating the disclosed classifier-free guidance for multiple conditionings inference diffusion model, in accordance with some aspects of the present disclosure.

FIG. 8 is a diagram illustrating a U-Net architecture for the disclosed diffusion model, in accordance with some aspects of the present disclosure.

FIG. 9 is a diagram illustrating a residual neural network block that may be employed by the disclosed diffusion model, in accordance with some aspects of the present disclosure.

FIG. 10 is a block diagram illustrating an example of a deep learning neural network that can be used to implement multimodal guidance distillation for efficient diffusion models, in accordance with some aspects of the present disclosure.

FIG. 11 is a block diagram illustrating an example of a convolutional neural network (CNN), in accordance with some aspects of the present disclosure.

FIG. 12 is a flow chart illustrating an example of a process for image processing, in accordance with some aspects of the present disclosure.

FIG. 13 is a block diagram illustrating an example computing system, in accordance with some aspects of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

A camera is a device that receives light and captures image frames, such as still images or video frames, using an image sensor. The terms “image,” “image frame,” and “frame” are used interchangeably herein. Cameras may include processors, such as image signal processors (ISPs), that can receive one or more image frames and process the one or more image frames. For example, a raw image frame captured by a camera sensor can be processed by an ISP to generate a final image. Processing by the ISP can be performed by a plurality of filters or processing blocks being applied to the captured image frame, such as denoising or noise filtering, edge enhancement, color balancing, contrast, intensity adjustment (such as darkening or lightening), tone adjustment, among others. Image processing blocks or modules may include lens/sensor noise correction, Bayer filters, de-mosaicing, color conversion, correction or enhancement/suppression of image attributes, denoising filters, sharpening filters, among others.

Cameras can be configured with a variety of image capture and image processing operations and settings. The different settings result in images with different appearances. Some camera operations are determined and applied before or during capture of the image, such as automatic exposure control (AEC) and automatic white balance (AWB) processing. Additional camera operations applied before, during, or after capture of an image include operations involving zoom (e.g., zooming in or out), ISO, aperture size, f/stop, shutter speed, and gain. Other camera operations can configure post-processing of an image, such as alterations to contrast, brightness, saturation, sharpness, levels, curves, or colors.

As previously mentioned, for image processing, generative models, such as diffusion models, can be employed to generate diverse high-resolution images. Generative models can be trained to generate image data based on provided conditions (e.g., which may also be referred to as conditionings). One or more conditions (e.g., an image, video, text, a pose, and/an edge(s)) may be provided to a generative model. Image data generated by a generative model may be new image data (e.g., based on training of the generative model). The new image data may be conditioned on the provided image, but not replicated from the provided image.

Diffusion models learn to generate data, such as output images, given training data. A diffusion model can create, based on conditions (e.g., an image, text, a pose, and/or an edge(s)), an output (e.g., an output image) that resembles the training data (e.g., including an input image) without being an exact copy. For example, a diffusion model may receive an input image of a specific building during the day and may also receive a text condition that instructs generation of an output image of that specific building at night. Based on those input conditions, the diffusion model can produce an output image that includes that specific building at night. The diffusion model may additionally receive a guidance scale that corresponds to a condition. A guidance scale is a scalar value (e.g., a number) that indicates a weight (or strength) for its corresponding condition to be applied for the output.

The technique behind diffusion models includes a forward process and a reverse diffusion process (e.g., in general, a sampling process of a generative model). During the forward process, a diffusion model can take an input image x₀, and gradually add Gaussian noise to the input image through a series of steps. After the forward process, during the reverse diffusion process, a neural network is trained to recover the original data by reversing the noising process. By being able to model the reverse process, new data can be generated.

Diffusion models with multi-model conditionings are becoming increasingly popular for various different applications including, but not limited to, image editing with text instructions (e.g., which may use an image, text, a pose, and/or an edge(s) as conditions), video generation and editing (e.g., which may use video, text, a pose, and/or an edge(s) as conditions), novel view synthesis, three-dimensional (3D) reconstruction, and editing 3D scenes with textual instructions.

Diffusion models are a family of algorithms for generative modelling that achieve state-of-the-art performance in several tasks (e.g., for generating images with text instructions). Many of these algorithms take multiple conditionings as input (e.g., text, an image, video, a pose, and/or an edge(s)), especially those algorithms that focus on editing. In order to trade-off quality (e.g., the general realism of the generated output image and non-presence of artifacts) and fidelity (e.g., how closely an output image follows an input image) to the input conditionings, these algorithms can make several inference runs, and the outputs from the inference runs are then linearly combined to get a final result (e.g., this process is referred to as a classifier-free guidance). Even one inference run is slow and inefficient in diffusion models and, as such, multiple inference runs required for the classifier-free guidance are considerably expensive, which can especially be a big issue for constrained hardware.

As such, improved systems and techniques for diffusion models that have a reduction in the number of required inference runs can be beneficial.

In one or more aspects of the present disclosure, systems, apparatuses, methods (also referred to as processes), and computer-readable media (collectively referred to herein as “systems and techniques”) are described herein for providing multimodal guidance distillation for efficient diffusion models. In one or more examples, the systems and techniques extend the idea of distilling classifier-free guidance for text to multiple conditionings (e.g., including text and an image).

In one or more examples, guidance scales (also referred to herein as guidance scale inputs) are provided as inputs to the model (e.g., instead of applying weight factors to outputs of the model), which can allow for the reduction of multiple inference runs to only one inference run without losing any quality or control. In one or more examples, guidance scales can be utilized as inputs to a denoising neural network (e.g., a U-Net), in a similar way as a time embedding, by adding a few linear layers in residual neural network (ResNet) blocks of the denoising neural network (e.g., a U-Net).

In one or more aspects, the systems and techniques allow for distillation to be performed in a simple manner. In one or more examples, the output of the disclosed model pipeline can be optimized to be close to the output of a standard classifier-free guidance for multiple conditionings inference diffusion model. As such, the systems and techniques distill classifier-free guidance components all at once with just one finetuning procedure. After the distillation finetuning, the disclosed model pipeline can produce comparable results (e.g., as compared to a standard classifier-free guidance for multiple conditionings inference diffusion model that performs multiple inference runs) in just one inference run without sacrificing any quality and/or functionality.

In one or more examples, during operation of the systems and techniques for multimodal guidance distillation for efficient diffusion models, a neural network of a diffusion model can obtain features (e.g., z_{feats1}) associated with an input image (e.g., Xₜ), a plurality of conditioning inputs (e.g., c₁, . . . , cₙ), and a plurality of guidance scale inputs (e.g., s₁, . . . , sₙ), where each guidance scale input of the plurality of guidance scale inputs can be associated with a respective conditioning input of the plurality of conditioning inputs. The neural network can generate output features (e.g., z_{feats3}) based on the features associated with the input image, the plurality of conditioning inputs, and the plurality of guidance scale inputs. The diffusion model can generate an output image (e.g., Xₜ₋₁) based on the output features. The output image can be a modified version of the input image based on the plurality of conditioning inputs (e.g., an input image can include a scene of the Eiffel Tower during the daytime, the conditioning inputs can include prompts for a nighttime scene and to swap the Eiffel Tower with Big Ben, and the output image can include the same scene at night and with the Eiffel Tower replaced with Big Ben).

In one or more examples, the neural network can include a plurality of layers, each layer of the plurality of layers can include a respective residual neural network block. In some examples, each respective residual neural network block can include a plurality of embedding functions, where each embedding function of the plurality of embedding functions can be configured to generate an embedding for a respective guidance scale of the plurality of guidance scales.

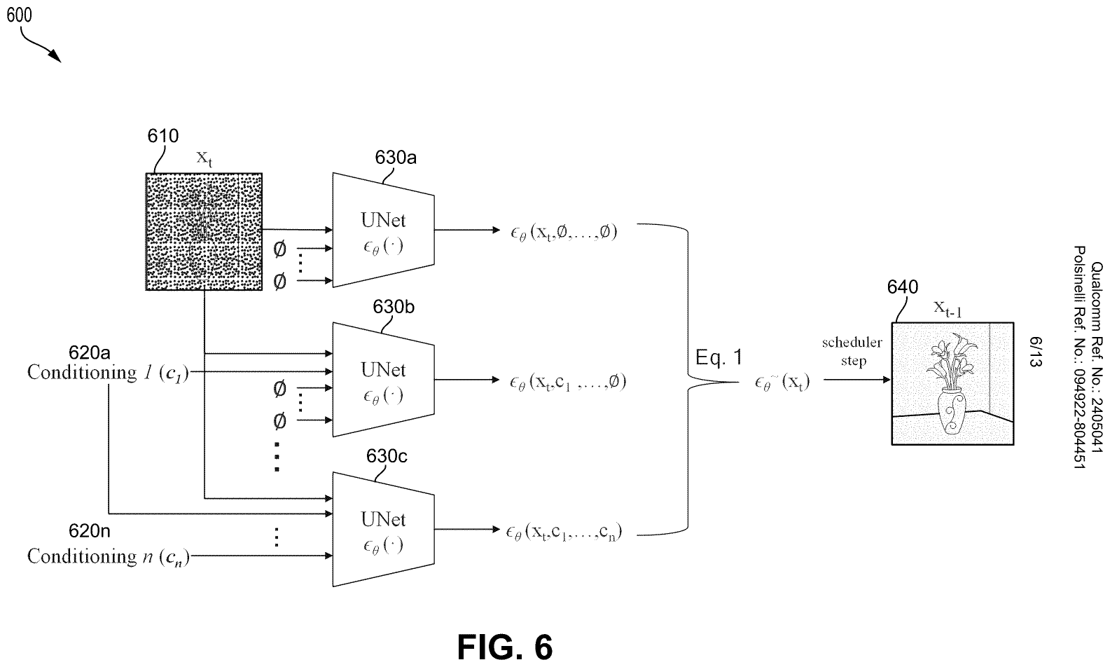

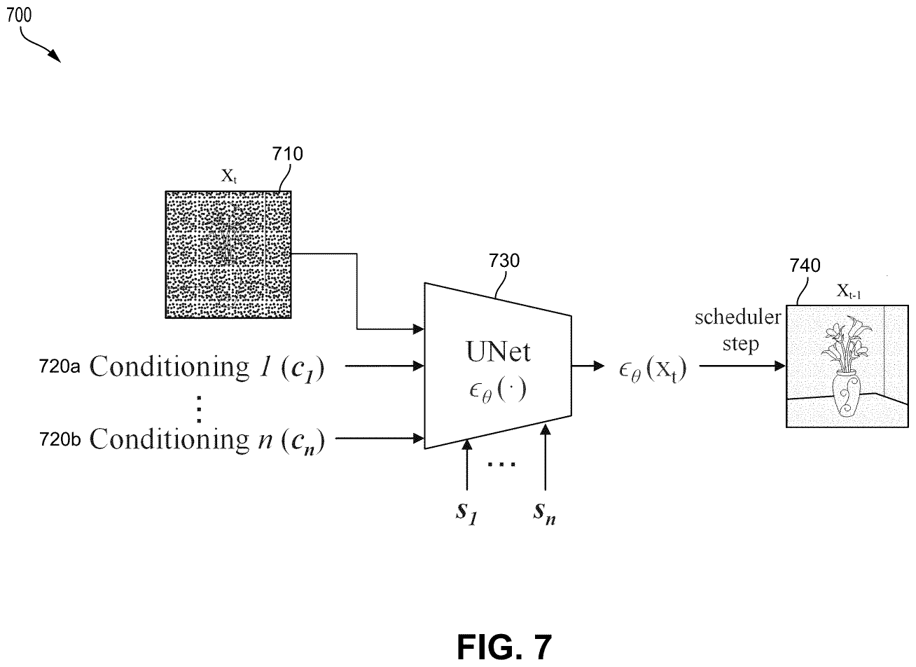

In one or more examples, the neural network is a convolutional neural network (CNN). In some examples, each conditioning input of the plurality of conditioning inputs can be an image conditioning, a text conditioning, a pose conditioning, or an edge conditioning. In one or more examples, each guidance scale of the plurality of guidance scales can be a respective scalar value, each scalar value can indicate a respective weight for the respective conditioning associated with the guidance scale. In some examples, the output image (e.g., Xₜ₋₁ of FIG. 7) can be compared to another output image (e.g., Xₜ₋₁ of FIG. 6) to obtain a difference (e.g., a loss), where the other output image is generated based on output features produced by a plurality of neural networks of another diffusion model (e.g., a standard classifier-free guidance for multiple conditionings inference model). In one or more examples, one or more parameters of the diffusion model can be adjusted based on the difference (e.g., the loss).

Additional aspects of the present disclosure are described in more detail below.

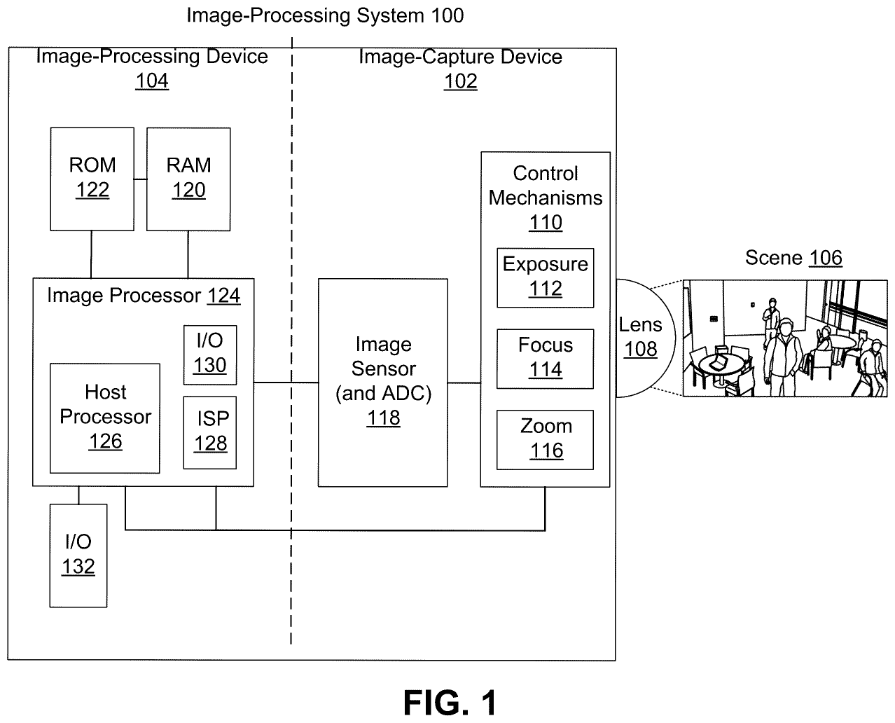

Various aspects of the application will be described with respect to the figures. FIG. 1 is a block diagram illustrating an example architecture of an image-processing system 100. The image-processing system 100 includes various components that are used to capture and process images, such as an image of a scene 106. The image-processing system 100 can capture image frames (e.g., still images or video frames). In some cases, the lens 108 and image sensor 118 (which may include an analog-to-digital converter (ADC)) can be associated with an optical axis. In one illustrative example, the photosensitive area of the image sensor 118 (e.g., the photodiodes) and the lens 108 can both be centered on the optical axis.

In some examples, the lens 108 of the image-processing system 100 faces a scene 106 and receives light from the scene 106. The lens 108 bends incoming light from the scene toward the image sensor 118. The light received by the lens 108 then passes through an aperture of the image-processing system 100. In some cases, the aperture (e.g., the aperture size) is controlled by one or more control mechanisms 110. In other cases, the aperture can have a fixed size.

The one or more control mechanisms 110 can control exposure, focus, and/or zoom based on information from the image sensor 118 and/or information from the image processor 124. In some cases, the one or more control mechanisms 110 can include multiple mechanisms and components. For example, the control mechanisms 110 can include one or more exposure-control mechanisms 112, one or more focus-control mechanisms 114, and/or one or more zoom-control mechanisms 116. The one or more control mechanisms 110 may also include additional control mechanisms besides those illustrated in FIG. 1. For example, in some cases, the one or more control mechanisms 110 can include control mechanisms for controlling analog gain, flash, HDR, depth of field, and/or other image capture properties.

The focus-control mechanism 114 of the control mechanisms 110 can obtain a focus setting. In some examples, focus-control mechanism 114 stores the focus setting in a memory register. Based on the focus setting, the focus-control mechanism 114 can adjust the position of the lens 108 relative to the position of the image sensor 118. For example, based on the focus setting, the focus-control mechanism 114 can move the lens 108 closer to the image sensor 118 or farther from the image sensor 118 by actuating a motor or servo (or other lens mechanism), thereby adjusting the focus. In some cases, additional lenses may be included in the image-processing system 100. For example, the image-processing system 100 can include one or more microlenses over each photodiode of the image sensor 118. The microlenses can each bend the light received from the lens 108 toward the corresponding photodiode before the light reaches the photodiode.

In some examples, the focus setting may be determined via contrast detection autofocus (CDAF), phase detection autofocus (PDAF), hybrid autofocus (HAF), or some combination thereof. The focus setting may be determined using the control mechanism 110, the image sensor 118, and/or the image processor 124. The focus setting may be referred to as an image capture setting and/or an image processing setting. In some cases, the lens 108 can be fixed relative to the image sensor and the focus-control mechanism 114.

The exposure-control mechanism 112 of the control mechanisms 110 can obtain an exposure setting. In some cases, the exposure-control mechanism 112 stores the exposure setting in a memory register. Based on the exposure setting, the exposure-control mechanism 112 can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 118 (e.g., ISO speed or film speed), analog gain applied by the image sensor 118, or any combination thereof. The exposure setting may be referred to as an image capture setting and/or an image processing setting.

The zoom-control mechanism 116 of the control mechanisms 110 can obtain a zoom setting. In some examples, the zoom-control mechanism 116 stores the zoom setting in a memory register. Based on the zoom setting, the zoom-control mechanism 116 can control a focal length of an assembly of lens elements (lens assembly) that includes the lens 108 and one or more additional lenses. For example, the zoom-control mechanism 116 can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 108 in some cases) that receives the light from the scene 106 first, with the light then passing through a focal zoom system between the focusing lens (e.g., lens 108) and the image sensor 118 before the light reaches the image sensor 118. The focal zoom system may, in some cases, include two positive (e.g., converging, convex) lenses of equal or similar focal length (e.g., within a threshold difference of one another) with a negative (e.g., diverging, concave) lens between them. In some cases, the zoom-control mechanism 116 moves one or more of the lenses in the focal zoom system, such as the negative lens and one or both of the positive lenses. In some cases, zoom-control mechanism 116 can control the zoom by capturing an image from an image sensor of a plurality of image sensors (e.g., including image sensor 118) with a zoom corresponding to the zoom setting. For example, the image-processing system 100 can include a wide-angle image sensor with a relatively low zoom and a telephoto image sensor with a greater zoom. In some cases, based on the selected zoom setting, the zoom-control mechanism 116 can capture images from a corresponding sensor.

The image sensor 118 includes one or more arrays of photodiodes or other photosensitive elements. Each photodiode measures an amount of light that eventually corresponds to a particular pixel in the image produced by the image sensor 118. In some cases, different photodiodes may be covered by different filters. In some cases, different photodiodes can be covered in color filters, and may thus measure light matching the color of the filter covering the photodiode. Various color filter arrays can be used such as, for example and without limitation, a Bayer color filter array, a quad color filter array (QCFA), and/or any other color filter array.

In some cases, the image sensor 118 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 118 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 110 may be included instead or additionally in the image sensor 118. The image sensor 118 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

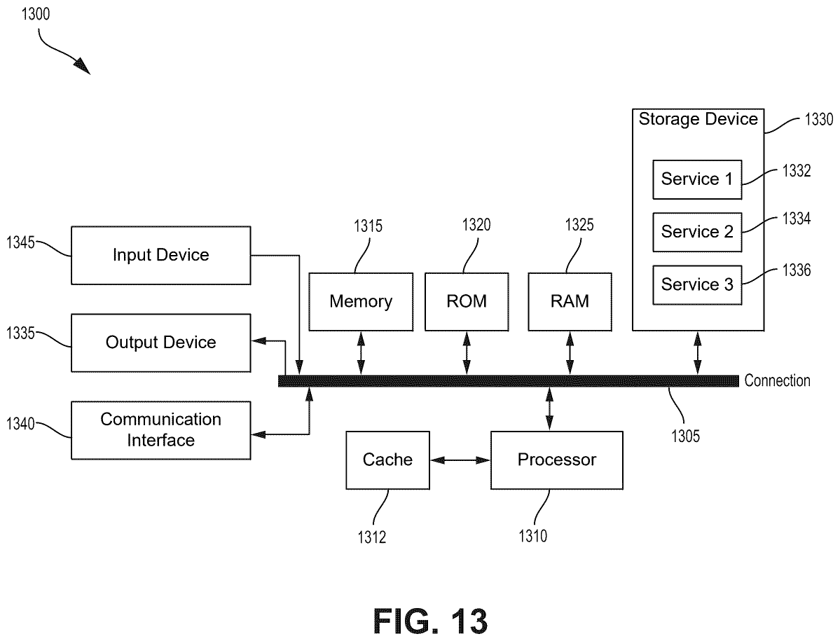

The image processor 124 may include one or more processors, such as one or more image signal processors (ISPs) (including ISP 128), one or more host processors (including host processor 126), and/or one or more of any other type of processor discussed with respect to the computing system 1300 of FIG. 13. The host processor 126 can be a digital signal processor (DSP) and/or other type of processor. In some implementations, the image processor 124 is a single integrated circuit or chip (e.g., referred to as a system-on-chip or SoC) that includes the host processor 126 and the ISP 128. In some cases, the chip can also include one or more input/output ports (e.g., input/output (I/O) ports 130), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 130 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General-Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 126 can communicate with the image sensor 118 using an I2C port, and the ISP 128 can communicate with the image sensor 118 using an MIPI port.

The image processor 124 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 124 may store image frames and/or processed images in random-access memory (RAM) 120, read-only memory (ROM) 122, a cache, a memory unit, another storage device, or some combination thereof.

Various input/output (I/O) devices 132 may be connected to the image processor 124. The I/O devices 132 can include a display screen, a keyboard, a keypad, a touchscreen, a trackpad, a touch-sensitive surface, a printer, any other output devices, any other input devices, or any combination thereof. In some cases, a caption may be input into the image-processing device 104 through a physical keyboard or keypad of the I/O devices 132, or through a virtual keyboard or keypad of a touchscreen of the I/O devices 132. The I/O devices 132 may include one or more ports, jacks, or other connectors that enable a wired connection between the image-processing system 100 and one or more peripheral devices, over which the image-processing system 100 may receive data from the one or more peripheral device and/or transmit data to the one or more peripheral devices. The I/O devices 132 may include one or more wireless transceivers that enable a wireless connection between the image-processing system 100 and one or more peripheral devices, over which the image-processing system 100 may receive data from the one or more peripheral device and/or transmit data to the one or more peripheral devices. The peripheral devices may include any of the previously-discussed types of the I/O devices 132 and may themselves be considered I/O devices 132 once they are coupled to the ports, jacks, wireless transceivers, or other wired and/or wireless connectors.

In some cases, the image-processing system 100 may be a single device. In some cases, the image-processing system 100 may be two or more separate devices, including an image-capture device 102 (e.g., a camera) and an image-processing device 104 (e.g., a computing device coupled to the camera). In some implementations, the image-capture device 102 and the image-capture device 102 may be coupled together, for example via one or more wires, cables, or other electrical connectors, and/or wirelessly via one or more wireless transceivers. In some implementations, the image-capture device 102 and the image-processing device 104 may be disconnected from one another.

As shown in FIG. 1, a vertical dashed line divides the image-processing system 100 of FIG. 1 into two portions that represent the image-capture device 102 and the image-processing device 104, respectively. The image-capture device 102 includes the lens 108, control mechanisms 110, and the image sensor 118. The image-processing device 104 includes the image processor 124 (including the ISP 128 and the host processor 126), the RAM 120, the ROM 122, and the I/O device 132. In some cases, certain components illustrated in the image-capture device 102, such as the ISP 128 and/or the host processor 126, may be included in the image-capture device 102. In some examples, the image-processing system 100 can include one or more wireless transceivers for wireless communications, such as cellular network communications, 802.11 wi-fi communications, wireless local area network (WLAN) communications, or some combination thereof.

The image-processing system 100 can be part of, or implemented by, a single computing device or multiple computing devices. In some examples, the image-processing system 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a laptop or notebook computer, a tablet computer, a set-top box, a smart television, a display device, a game console, an XR device (e.g., an HMD, smart glasses, etc.), an IoT (Internet-of-Things) device, a smart wearable device, a video streaming device, an Internet Protocol (IP) camera, or any other suitable electronic device(s).

While the image-processing system 100 is shown to include certain components, one of ordinary skill will appreciate that the image-processing system 100 can include more components than those shown in FIG. 1. The components of the image-processing system 100 can include software, hardware, or one or more combinations of software and hardware. For example, in some implementations, the components of the image-processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image-processing system 100.

In some examples, the computing system 1300 shown in FIG. 13 and further described below can include the image-processing system 100, the image-capture device 102, the image-processing device 104, or a combination thereof.

As noted above, various aspects of the present disclosure can use machine-learning models or systems.

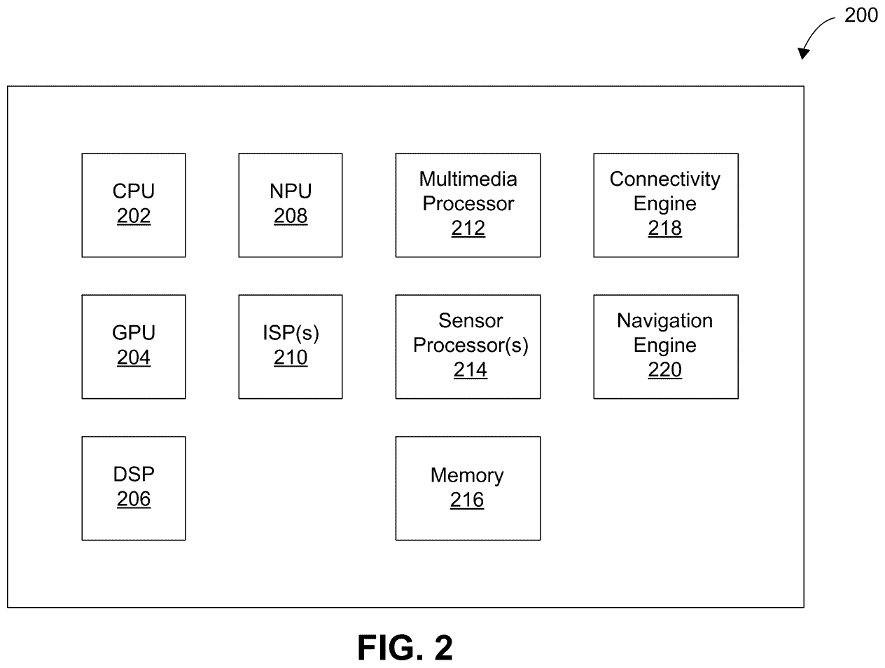

FIG. 2 illustrates an example implementation of a system 200, which may include a central processing unit (CPU 202) (which may be a multi-core CPU), configured to perform one or more of the functions described herein. Parameters or variables (e.g., neural signals and synaptic weights), system parameters associated with a computational device (e.g., neural network with weights), task information, among other information may be stored in a memory block associated with a neural processing unit (NPU 208), in a memory block associated with a CPU 202, in a memory block associated with a graphics processing unit (GPU 204), in a memory block associated with a digital signal processor (DSP 206), in a memory 216, and/or may be distributed across multiple blocks. Instructions executed at the CPU 202 may be loaded from a program memory associated with the CPU 202 or may be loaded from memory 216.

The system 200 may also include additional processing blocks tailored to specific functions, such as the GPU 204, the DSP 206, a connectivity engine 218, which may include fifth generation (5G) connectivity, fourth generation long term evolution (4G LTE) connectivity, Wi-Fi connectivity, USB connectivity, Bluetooth connectivity, and the like, and a multimedia processor 212 that may, for example, detect and recognize gestures. In one implementation, the NPU is implemented in the CPU 202, the DSP 206, and/or the GPU 204. The system 200 may also include one or more sensor processor(s) 214, one or more image signal processors (ISP(s) 210), and/or navigation engine 220, which may include a global positioning system. In some examples, the sensor processor(s) 214 can be associated with or connected to one or more sensors for providing sensor input(s) to the sensor processor(s) 214. For example, the one or more sensors and sensor processor(s) 214 can be provided in, coupled to, or otherwise associated with a same computing device.

The system 200 may be implemented as a system on a chip (SoC). The system 200 may be based on an Advanced Reduced Instruction Set Computer (RISC) Machine (ARM) instruction set. The system 200 and/or components thereof may be configured to perform machine learning techniques according to aspects of the present disclosure discussed herein. For example, the system 200 and/or components thereof may be configured to implement a machine-learning model (e.g., a diffusion model) as described herein and/or according to aspects of the present disclosure.

Machine learning (ML) can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, diffusion-based neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

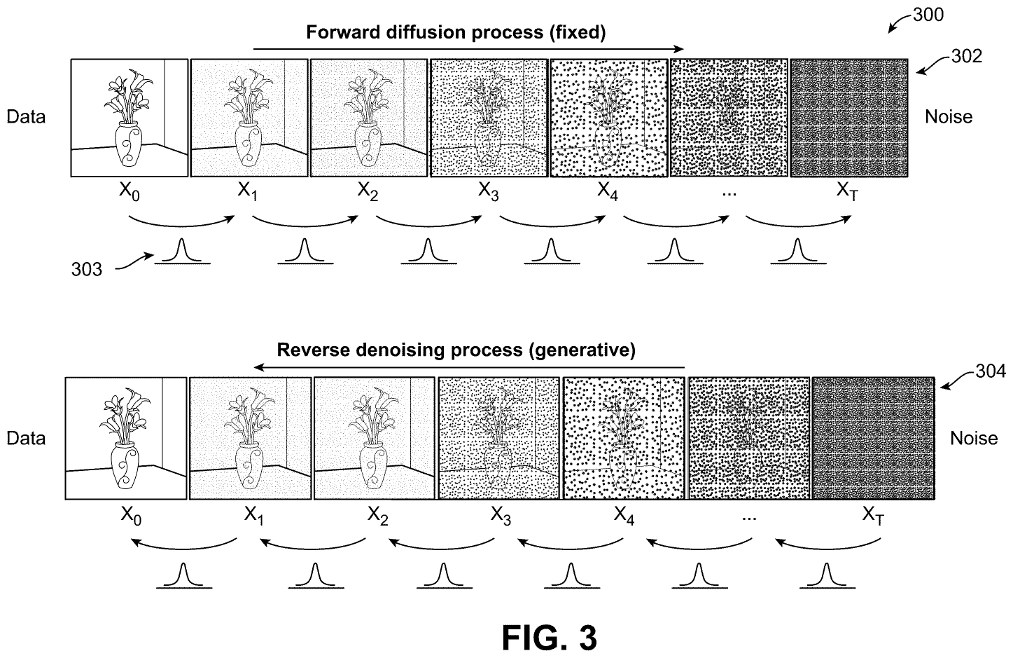

FIG. 3 provides two sets of images 300 that show the forward diffusion process (which is fixed) and the reverse diffusion process (which is learned) of a diffusion model. As shown in the forward diffusion process of FIG. 3, noise 303 is gradually added to a first set of images 302 at different time steps for a total of T time steps (e.g., making up a Markov chain), producing a sequence of noisy samples X₁ through X_{T}.

Diffusion models from a training perspective will take an image and will slowly add noise to the image to destroy the information in the image. In some aspects, the noise 303 is Gaussian noise. Each time step can correspond to each consecutive image of the first set of images 302 shown in FIG. 3. The initial image X₀ of FIG. 3 is of a cat. Addition of the noise 303 to each image (corresponding to noisy samples X₁ to X_{T}) results in gradual diffusion of the pixels in each image until the final image (corresponding to sample X_{T}) essentially matches the noise distribution. For example, by adding the noise, each data sample X₁ through X_{T} gradually loses its distinguishable features as the time step becomes larger, eventually resulting in the final sample X_{T} being equivalent to the target noise distribution, for instance a unit variance zero-Gaussian [symbol] (0, 1).

The second set of images 304 shows the reverse diffusion process in which X_{T} is the starting point with a noisy image (e.g., one that has Gaussian noise). The diffusion model can be trained to reverse the diffusion process (e.g., by training a model p_{θ}(Xₜ₋₁|xₜ)) to generate new data. In some aspects, a diffusion model can be trained by finding the reverse Markov transitions that maximize the likelihood of the training data. By traversing backwards along the chain of time steps, the diffusion model can generate the new data. For example, as shown in FIG. 3, the reverse diffusion process proceeds to generate X₀ as the image of the cat. In other cases, the input data and output data can vary based on the task for which the diffusion model is trained.

As noted above, the diffusion model is trained to be able to denoise or recover the original image X₀ in an incremental process as shown in the second set of images 304. In some aspects, the neural network of the diffusion model can be trained to recover Xₜ given Xₜ₋₁, such as provided in the below example equation:

$$q ( {x}_{t} \vert {x}_{t - 1} ) = 𝒩 ( {x}_{t} ; \sqrt{1 - {β}_{t}} {x}_{t - 1} , {β}_{t} I )$$

A diffusion kernel can be defined as:

$$Define \hat{{∝}_{t}} = {\prod }_{s = 1}^{t} ( 1 - {β}_{s} ) \to q ( {x}_{t} \vert {x}_{0} ) = 𝒩 ( {x}_{t} ; \sqrt{\hat{{∝}_{t}}} {x}_{0} , ( 1 - \hat{{∝}_{t}} ) I )$$

Sampling can be defined as follows:

$${x}_{t} = \sqrt{\hat{{∝}_{t}}} {x}_{0} + \sqrt{1 - \hat{{∝}_{t}}}$$

ε where ε˜ [symbol] (0, 1).

In some cases, the βₜ values schedule (also referred to as a noise schedule) is designed such that \hat{∝}_{T}→0 and q(x_{T}|x₀)≈ [symbol] (x_{T}; 0, I).

The diffusion model runs in an iterative manner to incrementally generate the input image X₀. In one example, the model may have twenty steps. However, in other examples, the number of steps can vary.

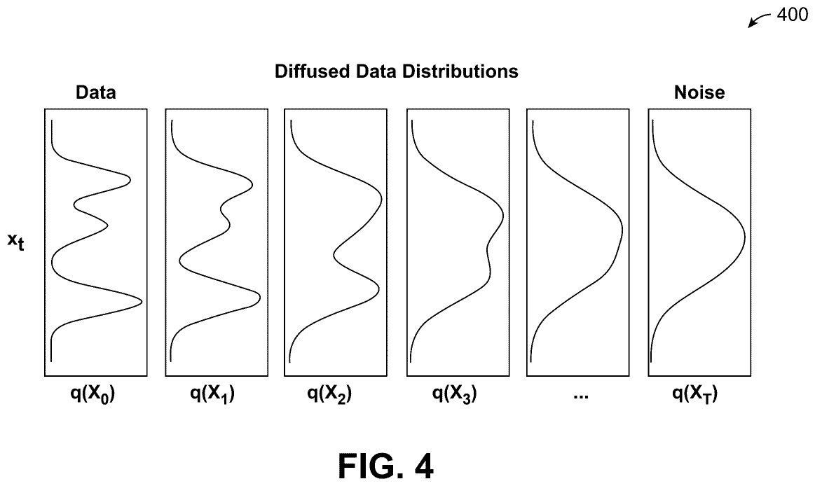

FIG. 4 is a diagram 400 illustrating how diffusion data is distributed from initial data to noise using a diffusion model in the forward diffusion direction. Note that the initial data q(X₀) is detailed in the initial stage of the diffusion process. An illustrative example of the data q(X₀) is the initial image of the cat shown in FIG. 3. As the diffusion model iterates and iteratively adds sampled noise to the data from t=0 to t=T, as shown in FIG. 4, the data becomes nosier and may ultimately result in pure noise (e.g., at q(X_{T})). The example of FIG. 4 illustrates the progression of the data and how it becomes diffused with noise in the forward diffusion process.

In some aspects, the diffused data distribution (e.g., as shown in FIG. 4) can be as follows:

$$q ( {x}_{t} ) = \int q ( {x}_{0} , {x}_{t} ) {dx}_{0} = \int q ( {x}_{0} ) q ( {x}_{t} \vert {x}_{0} ) {dx}_{0} .$$

In the above equation, q(x) represents the diffused data distribution, q(x₀, xₜ) represents the joint distribution, q(x₀) represents the input data distribution, and q(xₜ|x₀) is the diffusion kernel. In this regard, the model can sample xₜ˜q(xₜ) by first sampling x₀˜q(x) and then sampling Xₜ˜q(xₜ|x₀) (which may be referred to as ancestral sampling). The diffusion kernel takes the input and returns a vector or other data structure as output.

The following is a summary of a training algorithm and a sampling algorithm for a diffusion model. A training algorithm can include the following steps:

1: repeat
2: x₀~q(x₀)
3: t~Uniform ({1, . . . , T})
4: ϵ~ [symbol] (0, I)
5: Take gradient descent step on
${∇}_{∅} {‖ ∈ - {∈}_{∅} ( \sqrt{{\hat{∝}}_{t} {x}_{0}} + \sqrt{1 - {\hat{∝}}_{t}} ∈ , t ) ‖}^{2}$
6: until converged

A sampling algorithm can include the following steps:

1: x_{T}~ [symbol] (0, I)
2: for t = T, . . . , 1 do
3: Z~ [symbol] (0, I)
$4 : {x}_{t - 1} = \frac{1}{\sqrt{{\hat{∝}}_{t}}} ( {x}_{t} - \frac{1 - {\hat{∝}}_{t}}{\sqrt{1 - {\hat{∝}}_{t}}} {∈}_{∅} ( {x}_{t} , t ) ) + {σ}_{t} z$
5: end for
6: return x₀

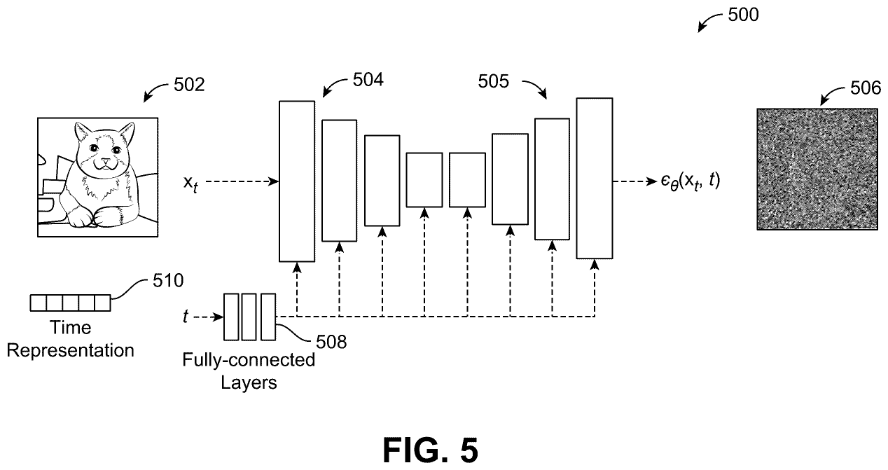

FIG. 5 is a diagram illustrating a U-Net architecture 500 for a diffusion model. The initial image 502 (e.g., of a cat) is provided to the U-Net architecture 500 which includes a series of residual networks (ResNet) blocks and self-attention layers to represent the network ϵ_{Θ} (Xₜ, t). The U-Net architecture 500 also includes fully connected layers 508. In some cases, time representation 510 can be sinusoidal positional embeddings or random Fourier features. Noisy output 506 from the forward diffusion process is also shown.

The U-Net architecture 500 includes a contracting path 504 and an expansive path 505 as shown in FIG. 5, which gives it the U-shaped architecture. The contracting path 504 can be a convolutional network that includes repeated convolutional layers (that apply convolutional operations), each followed by a rectified linear unit (ReLU) and a max pooling operation. When images are being processed (e.g., the image 502) during the contracting path 504, the spatial information of the image 502 is reduced as features are generated. The expansive path 505 combines the features and spatial information through a sequence of up-convolutions and concatenations with high-resolution features from the contracting path 504. Some of the layers can be self-attention layers, which leverage global interactions between semantic features at the end of the encoder to explicitly model full contextual information.

As previously mentioned, for image processing, generative models (e.g., diffusion models) may be employed to generate diverse high-resolution images. Generative models may be trained to generate image data based on provided conditions, which may also be referred to as conditionings. One or more conditions (e.g., an image, video, text, a pose, and/an edge(s)) can be provided to a generative model. Image data generated by a generative model can be new image data (e.g., based on training of the generative model). The new image data can be conditioned on the provided image, but not replicated from the provided image.

Diffusion models learn to generate data (e.g., as output images) given training data. A diffusion model may create, based on conditions (e.g., an image, text, a pose, and/or an edge(s)), an output (e.g., an output image) that resembles the training data (e.g., including an input image) without being an exact copy. For example, a diffusion model can receive an input image of a specific building during the day and can also receive a text condition that instructs generation of an output image of that specific building at night. Based on those input conditions, the diffusion model may produce an output image that includes that specific building at night. The diffusion model can additionally receive a guidance scale that corresponds to a condition. A guidance scale is a scalar value (e.g., a number) that indicates a weight (or strength) for its corresponding condition to be applied for the output.

The technique behind diffusion models involves a forward process and a reverse diffusion process (or, in general, a sampling process of a generative model). During the forward process, a diffusion model may take an input image x₀, and gradually add Gaussian noise to the input image through a series of steps. After the forward process, during the reverse diffusion process, a neural network is trained to recover the original data by reversing the noising process. By being able to model the reverse process, new data can be generated.

Diffusion models with multi-model conditionings are becoming increasingly popular for various different applications, such as image editing with text instructions (e.g., which may use an image, text, a pose, and/or an edge(s) as conditions), video generation and editing (e.g., which may use video, text, a pose, and/or an edge(s) as conditions), novel view synthesis, three-dimensional (3D) reconstruction, and editing 3D scenes with textual instructions.

Diffusion models are a family of algorithms for generative modelling that achieve state-of-the-art performance in several tasks (e.g., for generating images with text instructions). Many of these algorithms take multiple conditionings as input (e.g., text, an image, video, a pose, and/or an edge(s)), especially those algorithms that focus on editing. In order to trade-off quality (e.g., image resolution) and fidelity (e.g., how closely an output image follows an input image) to the input conditionings, these algorithms may make several inference runs, and the outputs from the inference runs are then linearly combined to get a final result (e.g., this process is referred to as a classifier-free guidance).

FIG. 6 shows an example of a diffusion model. In particular, FIG. 6 is a diagram illustrating an example of a standard classifier-free guidance for multiple conditionings inference diffusion model 600. In FIG. 6, the diffusion model is shown to include multiple neural networks 630a, 630b, 630c, which may each be a convolutional neural network (e.g., which may each be in the form of a U-Net architecture). Each neural network 630a, 630b, 630c can include a residual network (ResNet) block.

In FIG. 6, during operation of the diffusion model 600, each neural network 630a, 630b, 630c can obtain an input image 610 (Xₜ), for example features of the image, and conditioning inputs 620a, 620b (e.g., c₁, . . . , cₙ), where n is equal to the number of conditioning inputs (e.g., n is equal to two). In FIG. 6, the symbol “Ø” represents a null, or an empty set. For example, for image conditioning, null can mean a black image (e.g., all pixels have 0 values). For text, null can be an empty string. In such an example, a black image can be input to one or more of the neural networks 630a, 630b, 630c. In one or more examples, each conditioning input 620a, 620b (e.g., c₁, . . . , cₙ) may be an image conditioning, a text conditioning, a pose conditioning, or an edge conditioning.

Based on the input image 610 and the conditioning inputs 620a, 620b (e.g., c₁, . . . , cₙ) received by each neural network 630a, 630b, 630c, each neural network 630a, 630b, 630c can generate respective output features (e.g., ϵ_{θ}(xₜ, Ø, . . . , Ø), ϵ_{θ}(xₜ, c₁, . . . , Ø), and ϵ_{θ}(Xₜ, c₁, . . . , cₙ)). The diffusion model 600 can sum the output generated features (e.g., ϵ_{θ}(xₜ, Ø, . . . , Ø), ϵ_{θ}(xₜ, c₁, . . . , Ø), and ϵ_{θ}(xₜ, c₁, . . . , cₙ)) with weights (e.g., guidance scale inputs (e.g., s₁, . . . , sₙ)) to produce final output features of the network by using the following formula:

$${ϵ}_{θ}^{∼} ( {x}_{t} ) = {ϵ}_{θ} ( {x}_{t} , ∅ , … , ∅ ) + {s}_{1} ( {ϵ}_{θ} ( {x}_{t} , {c}_{1} , … , ∅ ) - {ϵ}_{θ} ( {x}_{t} , ∅ , … , ∅ ) ) + \text{} … + {s}_{n} ( {ϵ}_{θ} ( {x}_{t} , {c}_{1} , … , {c}_{n} ) - {ϵ}_{θ} ( {x}_{t} , {c}_{1} , … , {c}_{n - 1} , ∅ ) ) ,$$

where sᵢ is guidance scale input for conditioning i. Each guidance scale input sᵢ may be associated with a respective conditioning input 620a, 620b. In one or more examples, each guidance scale sᵢ may be a respective scalar value, where the scalar value may indicate a respective weight for the respective conditioning associated with the guidance scale. The diffusion model 600 can then use the final output features of the network (e.g., ϵ_{θ}^{˜}(xₜ)) to generate an output image 640 (Xₜ₋₁).

The number of neural network passes (e.g., inference passes) for the diffusion model 600 is equal to n plus one (e.g., n+1). For the diffusion model 600, if n (e.g., the number of conditioning inputs) is equal to two, the number of neural network passes will be three (e.g., 2+1=3). As previously mentioned, even one inference run is slow and inefficient in diffusion models. Thus, multiple inference runs required for the classifier-free guidance are considerably costly. Therefore, improved systems and techniques for diffusion models that have a reduction in the number of required inference runs can be useful.

In one or more aspects, the systems and techniques provide multimodal guidance distillation for efficient diffusion models. In one or more examples, the systems and techniques extend the idea of distilling classifier-free guidance for text to multiple conditionings (e.g., including text and an image).

In one or more examples, guidance scales can be provided as inputs to the model, (e.g., instead of applying weight factors to outputs of the model), which can allow for the reduction of multiple inference runs to only one inference run without losing any quality or control. In one or more examples, guidance scales may be utilized as inputs to a denoising neural network (e.g., a U-Net), in a similar way as a time embedding, by adding a few linear layers in residual neural network (ResNet) blocks of the denoising neural network (e.g., a U-Net).

In one or more aspects, the systems and techniques allow for distillation to be performed in a simple manner. In one or more examples, the output of the disclosed model pipeline may be optimized to be close to the output of a standard classifier-free guidance for multiple conditionings inference diffusion model. As such, the systems and techniques distill classifier-free guidance components all at once with only one finetuning procedure. After the distillation finetuning, the disclosed model pipeline can produce comparable results (e.g., as compared to a standard classifier-free guidance for multiple conditionings inference diffusion model that performs multiple inference runs) in just one inference run without sacrificing any quality and/or functionality.

FIG. 7 shows an example of the disclosed diffusion model. In particular, FIG. 7 is a diagram illustrating the disclosed classifier-free guidance for multiple conditionings inference diffusion model 700, in accordance with some aspects of the present disclosure. In FIG. 6, the diffusion model is shown to include a single neural networks 730, which may be a convolutional neural network (CNN), such as in the form of a U-Net architecture. The neural network 730 can include a ResNet block.

In FIG. 7, during operation of the diffusion model 700, the neural network 730 can obtain (e.g., receive as input) an input image 710 (Xₜ), for example features (e.g., z_{feats1}) associated with the input image, conditioning inputs 720a, 720b (e.g., c₁, . . . , cₙ), and guidance scale inputs (e.g., s₁, . . . , sₙ). In one or more examples, each conditioning input 720a, 720b (e.g., c₁, . . . , cₙ) may be an image conditioning, a text conditioning, a pose conditioning, or an edge conditioning. In some examples, n is equal to the number of conditioning inputs (e.g., n is equal to two). In some examples, each guidance scale input (e.g., s₁, . . . , sₙ) may be associated with a respective conditioning input 720a, 720b (e.g., c₁, . . . , cₙ). For example, guidance scale input S₁ may be associated with conditioning input 720a c₁. In one or more examples, each guidance scale may be a respective scalar value, where the scalar value may indicate a respective weight for the respective conditioning associated with the guidance scale.

The neural network 730 may generate output features of the network (e.g., ϵ_{θ}(xₜ)) based on the input image 710 (Xₜ), for example the features (e.g., z_{feats1}) associated with the input image, the conditioning inputs 720a, 720b (e.g., c₁, . . . , cₙ), and the guidance scale inputs (e.g., s₁, . . . , sₙ). The diffusion model 700 may generate an output image 740 (e.g., Xₜ₋₁) based on the output features. The output image 740 (e.g., Xₜ₋₁) may be a modified version of the input image 710 (Xₜ) based on the conditioning inputs 720a, 720b (e.g., c₁, . . . , cₙ).

In some aspects, the systems and techniques described herein can perform distillation in an efficient manner. For instance, the multiple conditionings inference diffusion model 700 can be finetuned so that the output of the diffusion model 700 is optimized to be close to the output of the standard classifier-free guidance for multiple conditionings inference performed by the diffusion model 600 of FIG. 6. The systems and techniques can thus distill classifier-free guidance components all at once with one finetuning procedure. According to an illustrative example of such distillation, the output image 740 (Xₜ₋₁) may be compared (e.g., by one or more processors of the diffusion model 700) to another output image (e.g., output image 640 (Xₜ₋₁) of FIG. 6) to obtain a difference (e.g., a loss). The other output image (e.g., output image 640 (Xₜ₋₁) of FIG. 6) is generated based on output features produced by a plurality of neural networks (e.g., neural networks 630a, 630b, 630c of FIG. 6) of another diffusion model (e.g., a standard classifier-free guidance for multiple conditionings inference diffusion model, such as diffusion model 600 of FIG. 6). In one or more examples, the diffusion model 700 can be finetuned by adjusting one or more parameters (e.g., weights) of the diffusion model 700 based on the difference (e.g., the loss).

The number of neural network passes (e.g., inference passes) for the diffusion model 700 of FIG. 7 is equal to one and, as such, the diffusion model 700 is efficient and has a reduced cost to run as compared to the diffusion model 600 of FIG. 6, which requires multiple network passes.

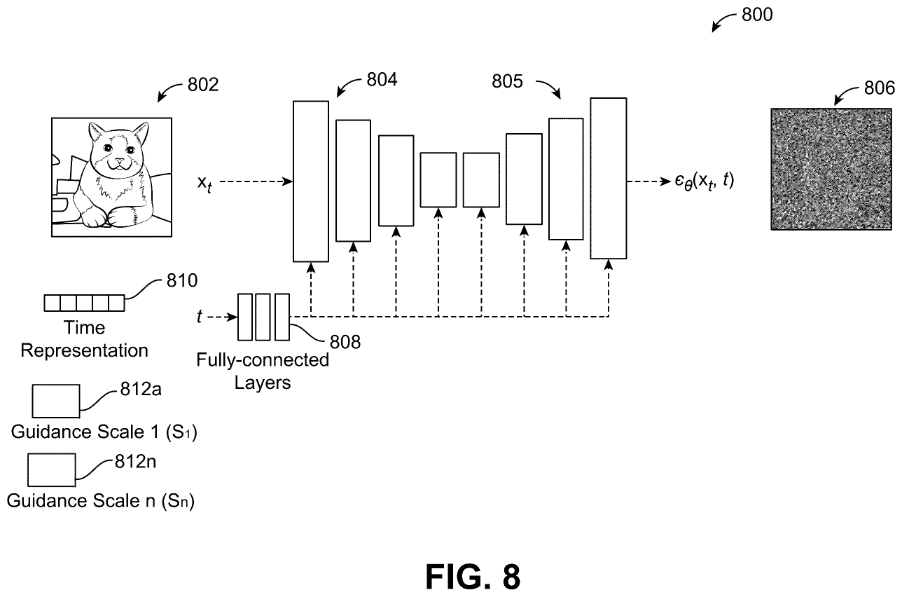

FIG. 8 is a diagram illustrating a U-Net architecture 800 that may be utilized for the disclosed diffusion model. In one or more examples, the U-Net architecture 800 of FIG. 8 may be employed for the neural network 730 (e.g., which may be in the form of a U-Net) of the diffusion model 700 of FIG. 7.

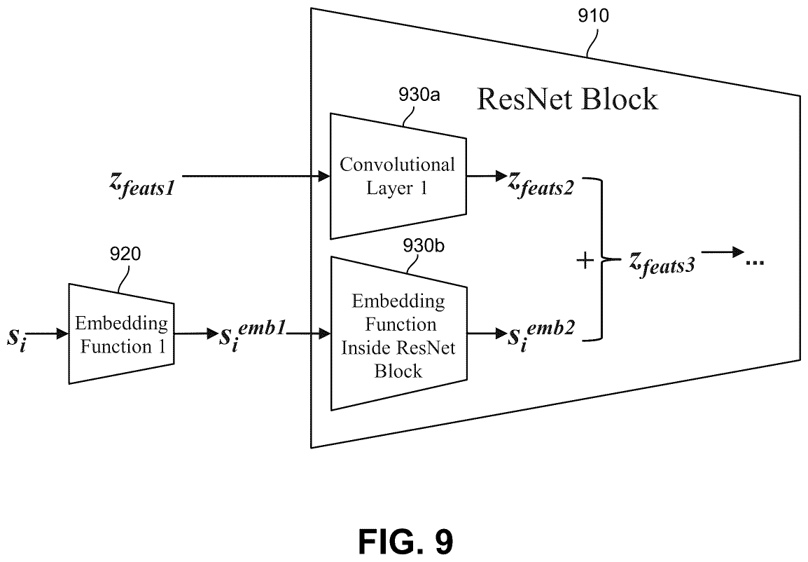

An initial image 802 is provided (input) to the U-Net architecture 800. The U-Net architecture includes a plurality of layers (e.g., self-attention layers, such as convolutional layers, which may be in a contracting path 804 and an expansive path 805 of the U-Net architecture 800). Each of the layers can include a respective ResNet block (e.g., ResNet block 910 of FIG. 9), to form the network ϵ_{Θ} (Xₜ, t). The U-Net architecture 800 also includes fully connected layers 808. In one or more examples, the time representation 810 can be sinusoidal positional embeddings or random Fourier features. A noisy output 806 from the forward diffusion process is also shown. In some examples, guidance scale inputs 812a, 812n can be input (along with the time representation 810) into the U-Net architecture 800.

In one or more examples, the U-Net architecture 800 includes a contracting path 804 and an expansive path 805 as shown in FIG. 8, which gives it the U-shaped architecture. The contracting path 804 can be a convolutional network that includes repeated convolutional layers (that apply convolutional operations), each followed by an ReLU and a max pooling operation. When images are being processed (e.g., the image 802) during the contracting path 804, the spatial information of the image 802 is reduced as features are generated. The expansive path 805 combines the features and spatial information through a sequence of up-convolutions and concatenations with high-resolution features from the contracting path 804. Some of the layers (e.g., in the contracting path 804 and the expansive path 805) can be self-attention layers, which leverage global interactions between semantic features at the end of the encoder to explicitly model full contextual information.

As previously mentioned, the layers (e.g., in the contracting path 804 and the expansive path 805) of the U-Net architecture 800 of FIG. 8 may each include a respective ResNet block. FIG. 9 shows an example of a ResNet block 910 that may be employed within the layers of the contracting path 804 and the expansive path 805 of the U-Net architecture 800 of FIG. 8. In particular, FIG. 9 is a diagram illustrating a ResNet block 910 that may be employed by the disclosed diffusion model (e.g., diffusion model 700 of FIG. 7). In FIG. 9, the ResNet block 910 may include one or more convolutional layers (e.g., convolutional layer 1 930a).

The ResNet block 910 may also include one or more embedding functions (e.g., embedding function 930b). Each embedding function (e.g., embedding function 930b) is associated with a respective guidance scale input (e.g., Sᵢ, which is the guidance scale input for conditioning i). As such, the number of embedding functions that the ResNet block 910 includes should be the same as the number of guidance scale inputs. All guidance scale inputs are embedded, as in FIG. 9, at once. In one or more examples, each embedding function (e.g., embedding function 930b) may be configured to generate an embedding (e.g., sᵢ^{emb2}) for a respective guidance scale (e.g., Sᵢ).

During operation, the ResNet block 910 can receive features (e.g., z_{feats1}) associated with an input image (e.g., image 802). The convolutional layer 930a (e.g., which may be in the contracting path 804 or the expansive path 805 of the U-Net architecture 800) can process the features (e.g., z_{feats1}) associated with the input image (e.g., image 802) to generate intermediate latent features (e.g., z_{feats2}).

A first embedding function 920 (e.g., embedding function 1) can generate a first embedding (e.g., sᵢ^{emb1}) based on the guidance scale input (e.g., sᵢ). The ResNet block 910 can receive the first embedding (e.g., sᵢ^{emb1}) as an input. The embedding function (e.g., embedding function 930b) within the ResNet block 910 can generate a second embedding (e.g., sᵢ^{emb2}) based on the first embedding (e.g., sᵢ^{emb1}). The intermediate latent features (e.g., z_{feats2}) and the second embedding (e.g., sᵢ^{emb2}) can be combined (e.g., summed or multiplied) to generate output features (e.g., z_{feats3}). The diffusion model 700 may generate an output image (e.g., output image 740 (e.g., Xₜ₋₁)) based on the output features (e.g., z_{feats3}).

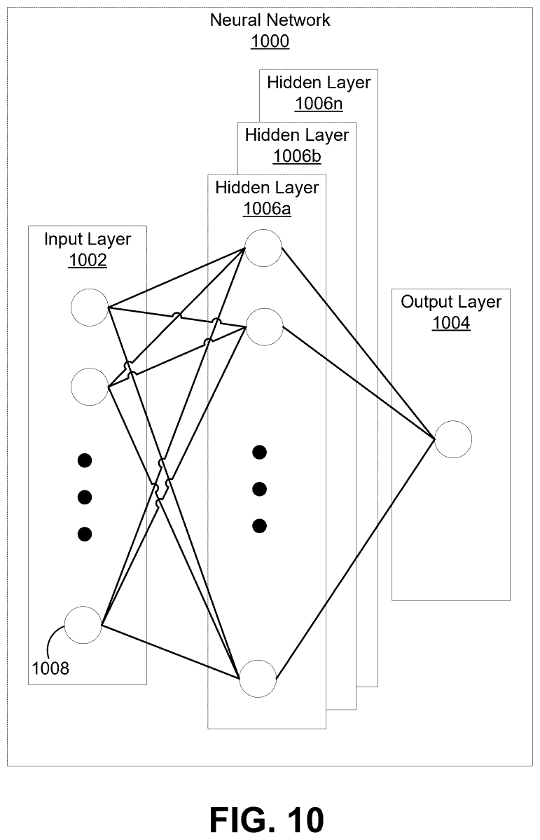

FIG. 10 is an illustrative example of a neural network 1000 (e.g., a deep-learning neural network) that can be used to implement machine-learning-based image generation, feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1000 may be an example of, or can implement, multimodal guidance distillation for efficient diffusion models.

An input layer 1002 includes input data. In one illustrative example, input layer 1002 can include data representing an image. Neural network 1000 includes multiple hidden layers hidden layers 1006a, 1006b, through 1006n. The hidden layers 1006a, 1006b, through hidden layer 1006n include “n” number of hidden layers, where “n” is an integer greater than or equal to one. The number of hidden layers can be made to include as many layers as needed for the given application. Neural network 1000 further includes an output layer 1004 that provides an output resulting from the processing performed by the hidden layers 1006a, 1006b, through 1006n. In one illustrative example, output layer 1004 can provide an image.

Neural network 1000 may be, or may include, a multi-layer neural network of interconnected nodes. Each node can represent a piece of information. Information associated with the nodes is shared among the different layers and each layer retains information as information is processed. In some cases, neural network 1000 can include a feed-forward network, in which case there are no feedback connections where outputs of the network are fed back into itself. In some cases, neural network 1000 can include a recurrent neural network, which can have loops that allow information to be carried across nodes while reading in input.

Information can be exchanged between nodes through node-to-node interconnections between the various layers. Nodes of input layer 1002 can activate a set of nodes in the first hidden layer 1006a. For example, as shown, each of the input nodes of input layer 1002 is connected to each of the nodes of the first hidden layer 1006a. The nodes of first hidden layer 1006a can transform the information of each input node by applying activation functions to the input node information. The information derived from the transformation can then be passed to and can activate the nodes of the next hidden layer 1006b, which can perform their own designated functions. Example functions include convolutional, up-sampling, data transformation, and/or any other suitable functions. The output of the hidden layer 1006b can then activate nodes of the next hidden layer, and so on. The output of the last hidden layer 1006n can activate one or more nodes of the output layer 1004, at which an output is provided. In some cases, while nodes (e.g., node 1008) in neural network 1000 are shown as having multiple output lines, a node has a single output and all lines shown as being output from a node represent the same output value.

In some cases, each node or interconnection between nodes can have a weight that is a set of parameters derived from the training of neural network 1000. Once neural network 1000 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1000 to be adaptive to inputs and able to learn as more and more data is processed.

Neural network 1000 may be pre-trained to process the features from the data in the input layer 1002 using the different hidden layers 1006a, 1006b, through 1006n in order to provide the output through the output layer 1004. In an example in which neural network 1000 is used to identify features in images, neural network 1000 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1000 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 1000 is trained well enough so that the weights of the layers are accurately tuned.

For the example of identifying objects in images, the forward pass can include passing a training image through neural network 1000. The weights are initially randomized before neural network 1000 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1000, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1000 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as

$${E}_{total} = \sum \frac{1}{2} {( target - output )}^{2} .$$

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1000 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and n denotes a learning as rate. The learning rate can be set to any suitable value, with a high learning rate including larger weight updates and a lower value indicating smaller weight updates.

Neural network 1000 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1000 can include any other deep network other than a CNN, such as an autoencoder, a deep belief nets (DBNs), a Recurrent Neural Networks (RNNs), among others.

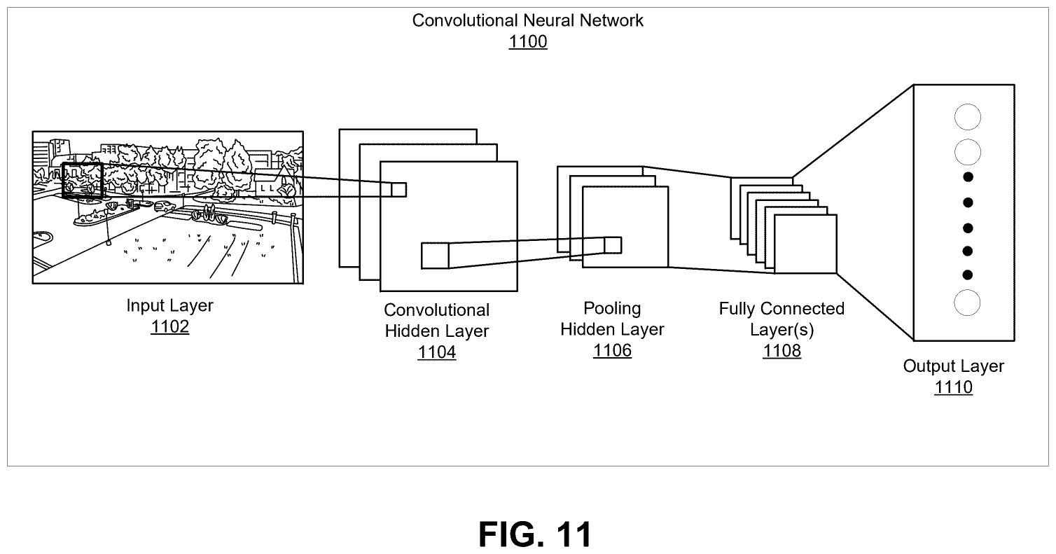

FIG. 11 is an illustrative example of a convolutional neural network (CNN) 1100. The input layer 1102 of the CNN 1100 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1104, an optional non-linear activation layer, a pooling hidden layer 1106, and fully connected layer 1108 (which fully connected layer 1108 can be hidden) to get an output at the output layer 1110. While only one of each hidden layer is shown in FIG. 11, one of ordinary skill will appreciate that multiple convolutional hidden layers, non-linear layers, pooling hidden layers, and/or fully connected layers can be included in the CNN 1100. As previously described, the output can indicate a single class of an object or can include a probability of classes that best describe the object in the image.

The first layer of the CNN 1100 can be the convolutional hidden layer 1104. The convolutional hidden layer 1104 can analyze image data of the input layer 1102. Each node of the convolutional hidden layer 1104 is connected to a region of nodes (pixels) of the input image called a receptive field. The convolutional hidden layer 1104 can be considered as one or more filters (each filter corresponding to a different activation or feature map), with each convolutional iteration of a filter being a node or neuron of the convolutional hidden layer 1104. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1104. Each connection between a node and a receptive field for that node learns a weight and, in some cases, an overall bias such that each node learns to analyze its particular local receptive field in the input image. Each node of the convolutional hidden layer 1104 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1104 is due to each node of the convolutional layer being applied to its corresponding receptive field. For example, a filter of the convolutional hidden layer 1104 can begin in the top-left corner of the input image array and can convolve around the input image. As noted above, each convolutional iteration of the filter can be considered a node or neuron of the convolutional hidden layer 1104. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1104. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1104.

The mapping from the input layer to the convolutional hidden layer 1104 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1104 can include several activation maps in order to identify multiple features in an image. The example shown in FIG. 11 includes three activation maps. Using three activation maps, the convolutional hidden layer 1104 can detect three different kinds of features, with each feature being detectable across the entire image.

In some examples, a non-linear hidden layer can be applied after the convolutional hidden layer 1104. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1100 without affecting the receptive fields of the convolutional hidden layer 1104.

The pooling hidden layer 1106 can be applied after the convolutional hidden layer 1104 (and after the non-linear hidden layer when used). The pooling hidden layer 1106 is used to simplify the information in the output from the convolutional hidden layer 1104. For example, the pooling hidden layer 1106 can take each activation map output from the convolutional hidden layer 1104 and generates a condensed activation map (or feature map) using a pooling function. Max-pooling is one example of a function performed by a pooling hidden layer. Other forms of pooling functions be used by the pooling hidden layer 1106, such as average pooling, L2-norm pooling, or other suitable pooling functions. A pooling function (e.g., a max-pooling filter, an L2-norm filter, or other suitable pooling filter) is applied to each activation map included in the convolutional hidden layer 1104. In the example shown in FIG. 11, three pooling filters are used for the three activation maps in the convolutional hidden layer 1104.

In some examples, max-pooling can be used by applying a max-pooling filter (e.g., having a size of 2×2) with a stride (e.g., equal to a dimension of the filter, such as a stride of 2) to an activation map output from the convolutional hidden layer 1104. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1104 having a dimension of 24×24 nodes, the output from the pooling hidden layer 1106 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1100.

The final layer of connections in the network is a fully-connected layer that connects every node from the pooling hidden layer 1106 to every one of the output nodes in the output layer 1110. Using the example above, the input layer includes 28×28 nodes encoding the pixel intensities of the input image, the convolutional hidden layer 1104 includes 3×24×24 hidden feature nodes based on application of a 5×5 local receptive field (for the filters) to three activation maps, and the pooling hidden layer 1106 includes a layer of 3×12×12 hidden feature nodes based on application of max-pooling filter to 2×2 regions across each of the three feature maps. Extending this example, the output layer 1110 can include ten output nodes. In such an example, every node of the 3×12×12 pooling hidden layer 1106 is connected to every node of the output layer 1110.

The fully connected layer 1108 can obtain the output of the previous pooling hidden layer 1106 (which should represent the activation maps of high-level features) and determines the features that most correlate to a particular class. For example, the fully connected layer 1108 can determine the high-level features that most strongly correlate to a particular class and can include weights (nodes) for the high-level features. A product can be computed between the weights of the fully connected layer 1108 and the pooling hidden layer 1106 to obtain probabilities for the different classes. For example, if the CNN 1100 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1110 can include an M-dimensional vector (in the prior example, M=10). M indicates the number of classes that the CNN 1100 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

In some aspects, training of one or more of the machine learning systems or neural networks described herein (e.g., such as the U-Net architecture 500 of FIG. 5, the diffusion model 700 of FIG. 7, the U-Net architecture 800 of FIG. 8, the ResNet block 910 of FIG. 9, among various other machine learning networks described herein) can be performed using online training (e.g., in some case on-device training), offline training, and/or various combinations of online and offline training. In some cases, online may refer to time periods during which the input data (e.g., such as the input image 710 of FIG. 7, the input image 802 of FIG. 8, etc.) is processed, for instance for performance of the multimodal guidance distillation by the systems and techniques described herein. In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an extended reality (XR) device, a vehicle or system/component of the vehicle, or other device) can perform online (or on-device) training of the pre-trained model to further adapt or tune the parameters of the model.

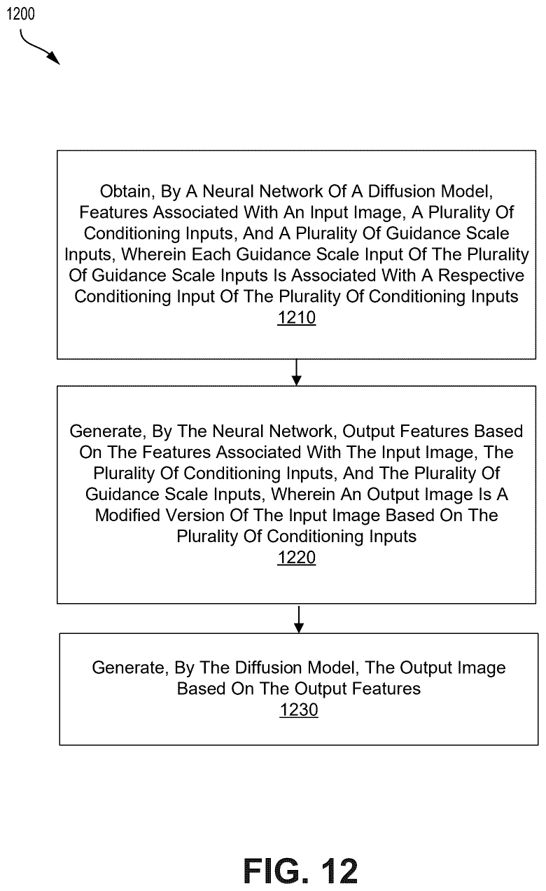

FIG. 12 is a flow chart illustrating an example of a process 1200 for multimodal guidance distillation for efficient diffusion models. The process 1200 can be performed by a computing device (e.g., computing system 1300 of FIG. 13) or by a component or system (e.g., a chipset, one or more processors such as one or more central processing units (CPUs), digital signal processors (DSPs), graphics processing units (GPUs), any combination thereof, and/or other type of processor(s), or other component or system) of the computing device. The operations of the process 1200 may be implemented as software components that are executed and run on one or more processors (e.g., processor 1310 of FIG. 13 or other processor(s)). Further, the transmission and reception of signals by the computing device in the process 1200 may be enabled, for example, by one or more antennas and/or one or more transceivers (e.g., wireless transceiver(s)).

At block 1210, the computing device (or component thereof) can obtain, via a neural network of a diffusion model, features (e.g., z_{feats1} of FIG. 9) associated with an input image, a plurality of conditioning inputs (e.g., conditioning inputs 720a, 720b, shown as c₁, . . . , cₙ, of FIG. 7), and a plurality of guidance scale inputs (e.g., guidance scale inputs s₁, . . . , sₙ of FIG. 7, guidance scale input s; of FIG. 9, etc.). Each guidance scale input of the plurality of guidance scale inputs is associated with a respective conditioning input of the plurality of conditioning inputs (e.g., guidance scale sᵢ is associated with conditioning input c₁, guidance scale s₂ is associated with conditioning input c₂, guidance scale s₃ is associated with conditioning input c₃, and so on). In some aspects, the neural network is a convolutional neural network used as part of the diffusion model. Other types of neural networks may also be used. In some cases, the neural network includes a plurality of layers, where each layer includes a respective residual neural network block (e.g., each of the layers in the contracting path 804 and an expansive path 805 of the U-Net architecture 800 of FIG. 8 can include a residual neural network (ResNet) block 910 as shown in FIG. 9). For instance, each respective residual neural network (ResNet) block can include a plurality of embedding functions (e.g., embedding function 930b of FIG. 9). As described herein, each embedding function of the plurality of embedding functions can be configured to generate an embedding (e.g., sᵢ^{emb2} shown in FIG. 9) for a respective guidance scale (e.g., sᵢ of FIG. 9) of the plurality of guidance scale inputs. Illustrative examples of conditioning inputs include an image conditioning, a text conditioning, a pose conditioning, an edge conditioning, a video conditioning, any combination thereof, and/or other conditioning inputs. In some cases, each guidance scale input of the plurality of guidance scale inputs is a respective scalar value. For instance, each scalar value can indicate a respective weight for the respective conditioning associated with the guidance scale input (e.g., guidance scale s₁ is a weight applied to the conditioning input c₁, guidance scale s₂ is a weight applied to the conditioning input c₂, guidance scale s₃ is a weight applied to the conditioning input c₃, and so on). In one illustrative example, the guidance scales can be applied as follows: ϵ_{θ}^{˜} (xₜ)=ϵ_{θ}(xₜ, Ø, . . . , Ø)+s₁(ϵ_{θ}(xₜ, c₁, . . . , Ø)−ϵ_{θ}(xₜ, Ø, . . . , Ø)+ . . . +sₙ(ϵ_{θ}(xₜ, c₁, . . . , cₙ)−ϵ_{θ}(xₜ, c₁, . . . , cₙ₋₁, Ø), where sᵢ is guidance scale for conditioning i.

At block 1220, the computing device (or component thereof) can generate, using the neural network, output features (e.g., z_{feats3} of FIG. 9) based on the features associated with the input image, the plurality of conditioning inputs, and the plurality of guidance scale inputs.

At block 1230, the computing device (or component thereof) can generate, using the diffusion model, the output image (e.g., Xₜ₋₁ of FIG. 7) based on the output features. The output image is a modified version of the input image based on the plurality of conditioning inputs. In one illustrative example, the input image can include a scene of the Great Pyramids in Egypt during the day with cloudy skies. The plurality of conditioning inputs can include prompts for a nighttime scene and for clear skies. Based on the conditioning inputs, the output image can include the same scene at night and with the sky clear (e.g., no clouds).

In some aspects, the computing device (or component thereof) can compare the output image to another output image to obtain a difference (e.g., a loss, such as an L1 loss (Median Absolute Error (MAE)), an L2 loss (Root Mean Squared Error (RMSE)), a cross-entropy loss, etc.). The other output image is generated based on output features produced by a plurality of neural networks of another diffusion model (e.g., the multiple conditionings inference diffusion model 600 of FIG. 6). The computing device (or component thereof) can adjust one or more parameters (e.g., weights, etc.) of the diffusion model based on the difference. For instance, the diffusion model 700 can be finetuned by adjusting one or more parameters (e.g., weights) of the diffusion model 700 based on the difference (e.g., the loss).

In some cases, the computing device of process 1200 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1200 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1200 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1200 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 13 is a block diagram illustrating an example of a computing system 1300, which may be employed for multimodal guidance distillation for efficient diffusion models. In particular, FIG. 13 illustrates an example of computing system 1300, which can be for example any computing device making up internal computing system, a remote computing system, a camera, or any component thereof in which the components of the system are in communication with each other using connection 1305. Connection 1305 can be a physical connection using a bus, or a direct connection into processor 1310, such as in a chipset architecture. Connection 1305 can also be a virtual connection, networked connection, or logical connection.

In some aspects, computing system 1300 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1300 includes at least one processing unit (CPU or processor) 1310 and connection 1305 that communicatively couples various system components including system memory 1315, such as read-only memory (ROM) 1320 and random access memory (RAM) 1325 to processor 1310. Computing system 1300 can include a cache 1312 of high-speed memory connected directly with, in close proximity to, or integrated as part of processor 1310.

Processor 1310 can include any general purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, speech, etc. Computing system 1300 can also include output device 1335, which can be one or more of a number of output mechanisms. In some instances, multimodal systems can enable a user to provide multiple types of input/output to communicate with computing system 1300.

Computing system 1300 can include communications interface 1340, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1340 may also include one or more range sensors (e.g., LIDAR sensors, laser range finders, RF radars, ultrasonic sensors, and infrared (IR) sensors) configured to collect data and provide measurements to processor 1310, whereby processor 1310 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1330 can include software services, servers, services, etc., that when the code that defines such software is executed by the processor 1310, it causes the system to perform a function. In some aspects, a hardware service that performs a particular function can include the software component stored in a computer-readable medium in connection with the necessary hardware components, such as processor 1310, connection 1305, output device 1335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for image processing, the apparatus comprising: one or more memories configured to store one or more features; and one or more processors coupled to the one or more memories and configured to: obtain, via a neural network of a diffusion model, features associated with an input image, a plurality of conditioning inputs, and a plurality of guidance scale inputs, wherein each guidance scale input of the plurality of guidance scale inputs is associated with a respective conditioning input of the plurality of conditioning inputs; generate, using the neural network, output features based on the features associated with the input image, the plurality of conditioning inputs, and the plurality of guidance scale inputs; and generate, using the diffusion model, an output image based on the output features, wherein the output image is a modified version of the input image based on the plurality of conditioning inputs.

Aspect 2. The apparatus of Aspect 1, wherein the neural network comprises a plurality of layers, each layer of the plurality of layers comprising a respective residual neural network block.

Aspect 3. The apparatus of Aspect 2, wherein each respective residual neural network block comprises a plurality of embedding functions, wherein each embedding function of the plurality of embedding functions is configured to generate an embedding for a respective guidance scale of the plurality of guidance scale inputs.

Aspect 4. The apparatus of any of Aspects 1 to 3, wherein the neural network is a convolutional neural network.

Aspect 5. The apparatus of any of Aspects 1 to 4, wherein each conditioning input of the plurality of conditioning inputs is an image conditioning, a text conditioning, a pose conditioning, an edge conditioning, or a video conditioning.

Aspect 6. The apparatus of any of Aspects 1 to 5, wherein each guidance scale input of the plurality of guidance scale inputs is a respective scalar value, each scalar value indicating a respective weight for the respective conditioning associated with the guidance scale input.

Aspect 7. The apparatus of any of Aspects 1 to 6, wherein the one or more processors are configured to: obtain, via a first neural network of a second diffusion model, features associated with an input image and a first conditioning input; generate, using the first neural network, first output features based on the features associated with the input image and the first conditioning input; obtain, via a second neural network of the second diffusion model, second features associated with the input image and a second conditioning input; generate, using the second neural network, second output features based on the features associated with the input image and the second conditioning input; and generate, using the second diffusion model, a second output image based on the first output features and the second output features.

Aspect 8. The apparatus of Aspect 7, wherein the one or more processors are configured to: compare the output image to the second output image to obtain a difference; and adjust one or more parameters of the diffusion model based on the difference.

Aspect 9. The apparatus of Aspect 8, wherein the one or more parameters comprise weights of the diffusion model.

Aspect 10. The apparatus of any of Aspects 7 to 9, wherein the one or more processors are configured to: combine the first output features and the second output features with weights to generate final output features; and generate the second output image based on the final output features.

Aspect 11. The apparatus of any of Aspects 1 to 10, further comprising one or more cameras configured to capture the input image.

Aspect 12. The apparatus of any of Aspects 1 to 11, further comprising a display configured to display the output image.

Aspect 13. A method of image processing, the method comprising: obtaining, by a neural network of a diffusion model, features associated with an input image, a plurality of conditioning inputs, and a plurality of guidance scale inputs, wherein each guidance scale input of the plurality of guidance scale inputs is associated with a respective conditioning input of the plurality of conditioning inputs; generating, by the neural network, output features based on the features associated with the input image, the plurality of conditioning inputs, and the plurality of guidance scale inputs; and generating, by the diffusion model, an output image based on the output features, wherein the output image is a modified version of the input image based on the plurality of conditioning inputs.

Aspect 14. The method of Aspect 13, wherein the neural network comprises a plurality of layers, each layer of the plurality of layers comprising a respective residual neural network block.

Aspect 15. The method of Aspect 14, wherein each respective residual neural network block comprises a plurality of embedding functions, wherein each embedding function of the plurality of embedding functions is configured to generate an embedding for a respective guidance scale of the plurality of guidance scale inputs.

Aspect 16. The method of any of Aspects 13 to 15, wherein the neural network is a convolutional neural network.

Aspect 17. The method of any of Aspects 13 to 16, wherein each conditioning input of the plurality of conditioning inputs is an image conditioning, a text conditioning, a pose conditioning, an edge conditioning, or a video conditioning.

Aspect 18. The method of any of Aspects 13 to 17, wherein each guidance scale of the plurality of guidance scale inputs is a respective scalar value, each scalar value indicating a respective weight for the respective conditioning associated with the guidance scale input.

Aspect 19. The method of any of Aspects 13 to 18, further comprising: obtain, via a first neural network of a second diffusion model, features associated with an input image and a first conditioning input; generate, using the first neural network, first output features based on the features associated with the input image and the first conditioning input; obtain, via a second neural network of the second diffusion model, second features associated with the input image and a second conditioning input; generate, using the second neural network, second output features based on the features associated with the input image and the second conditioning input; and generate, using the second diffusion model, a second output image based on the first output features and the second output features.

Aspect 20. The method of Aspect 19, further comprising: comparing the output image to the second output image to obtain a difference; and adjusting one or more parameters of the diffusion model based on the difference.

Aspect 21. The method of Aspect 20, wherein the one or more parameters comprise weights of the diffusion model.

Aspect 22. The method of any of Aspects 19 to 21, wherein the one or more processors are configured to: combine the first output features and the second output features with weights to generate final output features; and generate the second output image based on the final output features.

Aspect 23. A non-transitory computer-readable medium having stored thereon instructions that, when executed by one or more processors, cause the one or more processors to: obtain, via a neural network of a diffusion model, features associated with an input image, a plurality of conditioning inputs, and a plurality of guidance scale inputs, wherein each guidance scale input of the plurality of guidance scale inputs is associated with a respective conditioning input of the plurality of conditioning inputs; generate, using the neural network, output features based on the features associated with the input image, the plurality of conditioning inputs, and the plurality of guidance scale inputs; and generate, using the diffusion model, an output image based on the output features, wherein the output image is a modified version of the input image based on the plurality of conditioning inputs.

Aspect 24. The non-transitory computer-readable medium of Aspect 23, wherein the neural network comprises a plurality of layers, each layer of the plurality of layers comprising a respective residual neural network block.

Aspect 25. The non-transitory computer-readable medium of Aspect 24, wherein each respective residual neural network block comprises a plurality of embedding functions, wherein each embedding function of the plurality of embedding functions is configured to generate an embedding for a respective guidance scale of the plurality of guidance scale inputs.

Aspect 26. The non-transitory computer-readable medium of any of Aspects 23 to 25, wherein the neural network is a convolutional neural network.

Aspect 27. The non-transitory computer-readable medium of any of Aspects 23 to 26, wherein each conditioning input of the plurality of conditioning inputs is an image conditioning, a text conditioning, a pose conditioning, an edge conditioning, or a video conditioning.

Aspect 28. The non-transitory computer-readable medium of any of Aspects 23 to 27, wherein each guidance scale input of the plurality of guidance scale inputs is a respective scalar value, each scalar value indicating a respective weight for the respective conditioning associated with the guidance scale input.

Aspect 29. The non-transitory computer-readable medium of any of Aspects 23 to 28, wherein the instructions, when executed by the one or more processors, cause the one or more processors to: obtain, via a first neural network of a second diffusion model, features associated with an input image and a first conditioning input; generate, using the first neural network, first output features based on the features associated with the input image and the first conditioning input; obtain, via a second neural network of the second diffusion model, second features associated with the input image and a second conditioning input; generate, using the second neural network, second output features based on the features associated with the input image and the second conditioning input; and generate, using the second diffusion model, a second output image based on the first output features and the second output features.

Aspect 30. The non-transitory computer-readable medium of Aspect 29, wherein the instructions, when executed by the one or more processors, cause the one or more processors to: compare the output image to the second output image to obtain a difference; and adjust one or more parameters of the diffusion model based on the difference.

Aspect 31. The non-transitory computer-readable medium of Aspect 30, wherein the one or more parameters comprise weights of the diffusion model.

Aspect 32. The non-transitory computer-readable medium of any of Aspects 29 to 31, wherein the instructions, when executed by the one or more processors, cause the one or more processors to: combine the first output features and the second output features with weights to generate final output features; and generate the second output image based on the final output features.

Aspect 33. An apparatus for image processing, the apparatus including one or more means for performing operations according to any of Aspects 13 to 22.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for image processing, the apparatus comprising:
one or more memories configured to store one or more features; and
one or more processors coupled to the one or more memories and configured to:
obtain, via a neural network of a diffusion model, features associated with an input image, a plurality of conditioning inputs, and a plurality of guidance scale inputs, wherein each guidance scale input of the plurality of guidance scale inputs is associated with a respective conditioning input of the plurality of conditioning inputs;
generate, using the neural network, output features based on the features associated with the input image, the plurality of conditioning inputs, and the plurality of guidance scale inputs; and
generate, using the diffusion model, an output image based on the output features, wherein the output image is a modified version of the input image based on the plurality of conditioning inputs.

2. The apparatus of claim 1, wherein the neural network comprises a plurality of layers, each layer of the plurality of layers comprising a respective residual neural network block.

3. The apparatus of claim 2, wherein each respective residual neural network block comprises a plurality of embedding functions, wherein each embedding function of the plurality of embedding functions is configured to generate an embedding for a respective guidance scale of the plurality of guidance scale inputs.

4. The apparatus of claim 1, wherein the neural network is a convolutional neural network.

5. The apparatus of claim 1, wherein each conditioning input of the plurality of conditioning inputs is an image conditioning, a text conditioning, a pose conditioning, an edge conditioning, or a video conditioning.

6. The apparatus of claim 1, wherein each guidance scale input of the plurality of guidance scale inputs is a respective scalar value, each scalar value indicating a respective weight for the respective conditioning associated with the guidance scale input.

7. The apparatus of claim 1, wherein the one or more processors are configured to:
obtain, via a first neural network of a second diffusion model, features associated with an input image and a first conditioning input;
generate, using the first neural network, first output features based on the features associated with the input image and the first conditioning input;
obtain, via a second neural network of the second diffusion model, second features associated with the input image and a second conditioning input;
generate, using the second neural network, second output features based on the features associated with the input image and the second conditioning input; and
generate, using the second diffusion model, a second output image based on the first output features and the second output features.

8. The apparatus of claim 7, wherein the one or more processors are configured to:
compare the output image to the second output image to obtain a difference; and
adjust one or more parameters of the diffusion model based on the difference.

9. The apparatus of claim 8, wherein the one or more parameters comprise weights of the diffusion model.

10. The apparatus of claim 7, wherein the one or more processors are configured to:
combine the first output features and the second output features with weights to generate final output features; and
generate the second output image based on the final output features.

11. The apparatus of claim 1, further comprising one or more cameras configured to capture the input image.

12. The apparatus of claim 1, further comprising a display configured to display the output image.

13. A method of image processing, the method comprising:
obtaining, by a neural network of a diffusion model, features associated with an input image, a plurality of conditioning inputs, and a plurality of guidance scale inputs, wherein each guidance scale input of the plurality of guidance scale inputs is associated with a respective conditioning input of the plurality of conditioning inputs;
generating, by the neural network, output features based on the features associated with the input image, the plurality of conditioning inputs, and the plurality of guidance scale inputs; and
generating, by the diffusion model, an output image based on the output features, wherein the output image is a modified version of the input image based on the plurality of conditioning inputs.

14. The method of claim 13, wherein the neural network comprises a plurality of layers, each layer of the plurality of layers comprising a respective residual neural network block.

15. The method of claim 14, wherein each respective residual neural network block comprises a plurality of embedding functions, wherein each embedding function of the plurality of embedding functions is configured to generate an embedding for a respective guidance scale of the plurality of guidance scale inputs.

16. The method of claim 13, wherein the neural network is a convolutional neural network.

17. The method of claim 13, wherein each conditioning input of the plurality of conditioning inputs is an image conditioning, a text conditioning, a pose conditioning, an edge conditioning, or a video conditioning.

18. The method of claim 13, wherein each guidance scale of the plurality of guidance scale inputs is a respective scalar value, each scalar value indicating a respective weight for the respective conditioning associated with the guidance scale input.

19. The method of claim 13, further comprising:
obtain, via a first neural network of a second diffusion model, features associated with an input image and a first conditioning input;
generate, using the first neural network, first output features based on the features associated with the input image and the first conditioning input;
obtain, via a second neural network of the second diffusion model, second features associated with the input image and a second conditioning input;
generate, using the second neural network, second output features based on the features associated with the input image and the second conditioning input; and
generate, using the second diffusion model, a second output image based on the first output features and the second output features.

20. The method of claim 19, further comprising:
comparing the output image to the second output image to obtain a difference; and
adjusting one or more parameters of the diffusion model based on the difference.
